(19) United States
(12) Patent Application Publication
(10) Pub. No.: US 2013/0003777 A1
(43) Pub. Date: Jan. 3, 2013

(54) Multi Wavelength DTS Fiber Window with PSC Fiber

(75) Inventors: Mikko Jaaskelainen, Katy, TX (US); Kent Kalar, Austin, TX (US)

(73) Assignees: Kent KALAR, Austin, TX (US); Mikko JAASKELAINEN, Katy, TX (US)

(21) Appl. No.: 13/635,295

(22) PCT Filed: Mar. 19, 2011
(86) PCT No.: PCT/US2011/000501

§ 371 Date: Sep. 14, 2012

Related U.S. Application Data
(60) Provisional application No. 61/340,626, filed on Mar. 19, 2010.

(51) Int. Cl. G01K 15/00

(52) U.S. Cl. 374/1; 374/E15.001

(57) ABSTRACT

A DTS system resistant to hydrogen induced attenuation losses during the service life of an installation at both low and high temperatures using matched multi-wavelength DTS automatic calibration technology in combination with designed hydrogen tolerant Pure Silica Core (PSC) optical fibers.

### BACKGROUND AND FIELD OF THE DISCLOSURE

1. Field

The present invention relates to the use of optical fiber distributed temperature systems used in down-hole hydrogen environments and particularly to the use of hydrogen tolerant PSC fibers in combination with selected multi wavelength DTS technology.

2. Cross Reference To Related Applications

This application claims the benefit of U.S. provisional Ser. No. 61/340,626 filed Mar. 19, 2010.

### BACKGROUND

Raman based Distributed Temperature Sensing (DTS) was invented in the early 1980's, and was first deployed in the Oil & Gas industry in the 1990's. DTS is today widely used in conventional oil wells with great track record. Successful applications range from monitoring of water injection, gas lift, well integrity, flow modeling to thermal asset monitoring.

One of the more challenging down-hole applications is a well with high temperatures and the presence of hydrogen in the well. An example application is Steam Assisted Gravity Drainage (SAGD) technologies being used as an enhanced oil recovery technology for producing heavy crude oil and bitumen, such as in the Canadian tar sands. Early deployments of optical fibers in hydrogen rich hot wells experienced fiber failures due to increased optical attenuation, also known as fiber darkening.

Fiber darkening, which is evidenced by an increased optical attenuation, occurs in telecommunication grade fibers when hydrogen reacts with dopants or defect sites in the fiber. If not addressed this can result in a non-functional temperature measurement over time.

Most DTS Systems are based on the Optical Time Domain Reflectometry (OTDR) principle. A very short light pulse is launched into an optical fiber and the pulse interacts with the fused silica in the optical fiber as it propagates down the fiber. This interaction will cause light to scatter back along the full length of the optical fiber. The backscattered light will consist of 3 different components, Rayleigh, Brillouin and Raman backscattered light.

The Rayleigh component is scattered back at the same wavelength as the launched pulse whereas both the Brillouin and Raman components are shifted in wavelength. Measurement of these various components can be used to measure a number of parameters, especially temperature and strain. The location of these parameter measurements can be determined by measuring the time of flight between the transmitted pulse and the reflected light.

To deal with the deleterious effects of hydrogen darkening a number of solutions have been proposed, most of which have addressed the issue in specific applications, although not all can be successfully used in every instance, especially in very high temperature (>150° C.) applications. Fixed cables can be manufactured with a hydrogen scavenging gel in the cable. The hydrogen scavenging gel can be viewed as a sponge soaking up the hydrogen. At some point in time, the sponge will be saturated if there is enough hydrogen present. Hydrogen scavenging gel is used in applications below 150° C. as the gels break down at elevated temperatures and begin to release hydrogen.

Another mitigation approach for hydrogen darkening is carbon-coated fibers. These can effectively deal with hydrogen attack in optical fibers up to 150° C. and in some cases high quality carbon coatings can be used to higher temperatures for short periods of time. But both scavenging gels and carbon coatings are not suitable to high temperature wells. The growing need to recover heavy oils has led to steam driven technologies that approach 300° C.

Another approach that has received much attention in the mitigation of hydrogen darkening is the use of Pure Silica Core (PSC) optical fibers. PSC fibers can be prepared which are free from added chemicals and dopants, which are the precursors to reaction with hydrogen. This approach can be more effective than either gels or carbon coatings but can still exhibit hydrogen-induced attenuation at certain frequencies when exposed to free hydrogen at high temperatures.

Combinations of these approaches have been described. US application publication 20060222306A1 describes the development of an optical fiber resistant to hydrogen induced losses across a wide temperature range that uses a pure silica core and a hydrogen retarding layer of either carbon, metal, or silicon nitride, then a further cladding layer and a protective outer sheath.

Yet another approach to hydrogen-induced attenuation has been through the DTS systems by use of multi wavelength approaches. In U.S. Pat. No. 7,628,531 a DTS system with two light sources was used and was shown to be able to correct for errors generated by the ambiguities of a local sensing fiber cable. It was found that a secondary light source whose Stokes band coincides with the anti-Stokes band of a primary light source of the DTS system could be used for this purpose. This type of system is operated by using the primary light source in a measurement mode and collecting backscattered Raman Stokes and anti-Stokes light components and using that the intensities of those components to calculate temperatures. Then during a correction or calibration mode providing pulse of the secondary light source and collecting a backscattered Raman Stokes component of the secondary light source and using that to correct the Raman anti-Stokes profile from the primary light source while in measurement mode, and calculating a corrected temperature from the corrected anti-Stokes profile.

Similarly international publication WO2009011766A1 showed that some fibers darkened in an oil well could still be used for accurate measurement by application of a dual wavelength DTS system in which the secondary light energy into the fiber corresponded to the anti-Stokes wavelength of the primary light energy.

The increasing demands of oil exploration, as the decline rates of conventional light crude fields drive exploration increasingly toward heavier crudes, require a more robust solution than any of the above. One that can work in much higher temperature environments and be reliable for the entire service life of the fiber installation.

### BRIEF SUMMARY OF THE DISCLOSURE

This need is met by the invention of this disclosure.

The need is met by a combined multi wavelength DTS and optical fiber system in which the operating wavelengths are critical.

An aspect of this invention is a method for automatic calibration of temperature measurement in high temperature hydrogen rich environments during a measurement mode in a system using a fiber optic distributed sensor comprising the steps of: in a measurement mode providing a primary light source light pulse energy into a sensing fiber; collecting backscattered Raman Stokes and anti-Stokes light components; calculating temperatures using the intensities of the backscattered Raman Stokes and anti-Stokes light components; during a correction mode selecting a secondary light source and providing pulses of said secondary light source to the sensing fiber; collecting a backscattered Raman Stokes component of that secondary light source; using that Raman Stokes component collected from the secondary light source in said correction mode to correct a Raman anti-Stokes profile collected from the primary light source while in measurement mode; and calculating a corrected temperature from the corrected anti-Stokes profile. wherein the fiber optic distributed sensor is a pure silicon core (PSC) fiber; and wherein the primary light source is a 1064 nm wavelength source and the secondary light source is a 980 nm wavelength source.

In another aspect of this invention is a method for automatic calibration of temperature measurement in high temperature hydrogen rich environments in a system using a fiber optic distributed sensor including at least the steps of: injecting primary light energy into a sensor fiber using a primary light source; collecting backscattered Rayleigh and anti-Stokes light components from the primary light energy; measuring the attenuation of the backscattered Rayleigh light component and using it to correct the anti-Stokes light components; injecting secondary light energy into the sensor fiber using a secondary light source; collecting backscattered Rayleigh and Stokes light components of that secondary light source; measuring the attenuation of the backscattered Rayleigh light component and using it to correct the Stokes light components; calculating a temperature using the ratio of the corrected back-scattered anti-Stokes signal of the primary light energy and the corrected back-scattered Stokes signal of the secondary light energy; wherein the fiber optic distributed sensor is a pure silicon core (PSC) fiber; and wherein the primary light source is a 1064 nm wavelength source and the secondary light source is a 980 nm wavelength source.

In another aspect of this invention is a method for automatic calibration of temperature measurement in high temperature hydrogen rich environments in a system using a fiber optic distributed sensor comprising the steps of: injecting primary light energy into a sensor fiber using a primary light source; collecting back-scattered light energy at the Raman anti-Stokes wavelength of the primary light energy and measuring its intensity; injecting secondary light energy into the fiber at the Raman anti-Stokes wavelength of the primary light energy using a secondary light source; collecting back-scattered light energy at the Raman Stokes wavelength of the secondary light energy and measuring its intensity; and calculating a temperature using the back-scattered anti-Stokes signal of the primary light energy and the back-scattered Stokes signal of the secondary light energy; wherein the fiber optic distributed sensor is a pure silicon core (PSC) fiber; and wherein the primary light source is a 1030 nm wavelength source and the secondary light source is a 990 nm wavelength source.

In another aspect a single pulse modulating circuit can operate both the primary and secondary light sources. This aspect provides common modulating parameters for two lasers continuously, providing much better consecutive pulses with identical conditions in parameters such as modulating current amplitude, repetition rate and the pulse widths.

In another aspect, the primary light source and the secondary light source may also be the same light source, i.e., a dual wavelength laser source operable to provide at least two optical signals to the sensing fiber.

In another aspect the PSC fiber can also have a carbon coating to further enhance resistance to hydrogen-induced attenuation.

### BRIEF DESCRIPTION OF THE SEVERAL VIEWS OF THE DRAWINGS

Preferred embodiments and their advantages are best understood by reference to FIGS. 1 through 6.

FIG. 1 illustrates a single ended DTS system.

FIG. 2 illustrates a double ended DTS system.

FIG. 3 illustrates OTDR signal levels for four different optical probes.

FIG. 4 illustrates in (a) and (b) different temperature measurements using the probes of FIG. 3.

FIG. 5 illustrates the induced loss due to hydrogen regression for a representative PSC fiber.

FIG. 6 illustrates attention losses for critical wavelengths for the fiber of FIG. 5.

### DETAILED DESCRIPTION

Although certain embodiments of the present invention and their advantages have been described herein in detail, it should be understood that various changes, substitutions and alterations can be made without departing from the spirit and scope of the invention as defined by the appended claims. Moreover, the scope of the present invention is not intended to be limited to the particular embodiments of the processes, machines, manufactures, means, methods and steps described herein. As a person of ordinary skill in the art will readily appreciate from this disclosure, other processes, machines, manufactures, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufactures, means, methods or steps.

The classical way to measure distributed temperature using Raman scattering is to send a single pulse at wavelength λ₀ down the optical fiber and measure backscattered Raman Stokes (λₛ) and anti-Stokes (λₐₛ) components as a function of time. Time of flight will allow a calculation of the location, and the temperature can be calculated as a function of the ratio between the intensity of the anti-Stokes and Stokes components at any given location. FIG. 1 shows a single ended system 100 made up of single ended DTS system 120 and a fiber 130 of Length L deployed into the region of interest.

Fiber attenuation due to absorption and Rayleigh scattering introduce wavelength dependent attenuation. The peak wavelengths of the Stokes and anti-Stokes components are separated by 13[THz] from the transmitted pulse. A system operating at λ₀=1550 nm produces Stokes wavelength λₛ at 1650 nm and anti-Stokes wavelength λₐₛ at 1450 nm. This difference in wavelength dependent optical attenuation (Δα) between the Stokes and anti-Stokes wavelengths must be compensated for. This is often added to the fundamental Raman equation below where the impact of differential attenuation Δα is corrected for over distance z.

$$R ( T ) = \frac{{I}_{AS}}{{I}_{S}} = {( \frac{{λ}_{s}}{{λ}_{as}} )}^{4} \cdot exp ( - \frac{hc {υ}^{′}}{kT} ) \cdot exp ( - Δα z )$$

The underlying fundamental assumption for accurate temperature measurements with a single wavelength DTS system is a constant differential attenuation Δα.

This assumption is not valid in many applications. Examples of situations where the differential loss Δα varies are cabling induced bends, radiation induced attenuation or hydrogen-induced attenuation to name a few.

Advantages of a classical single ended system are the simple deployment and long reach in applications where the differential attenuation between Stokes and anti-Stokes components remain constant.

Disadvantage of a classical single wavelength DTS system is that it will experience significant measurement errors due to wavelength dependent dynamic attenuation when e.g. the fiber is exposed to hydrogen. The total increase in optical attenuation in many fibers may be in the order of 10's of dB/km, and may exceed the dynamic range of the system.

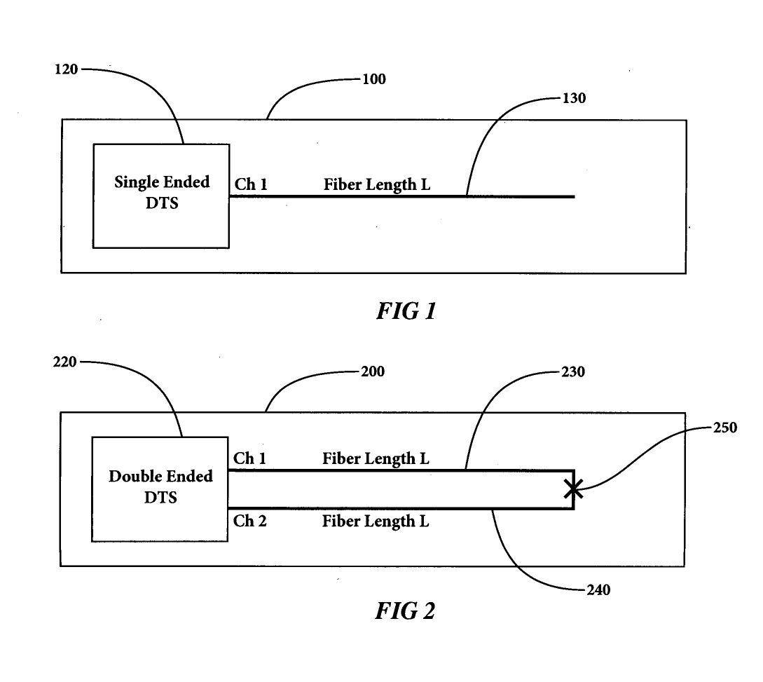

The impact of varying differential attenuation Δα can be mitigated using single wavelength DTS systems with double ended fiber deployments. FIG. 2 below show a double-ended system 200.

A fiber is deployed in a loop configuration of two fibers (230, 240) of length L and a full temperature trace is taken from channel 1 to channel 2 for a total fiber length of 2L. A second full temperature trace is taken from channel 2 giving two temperature points at every point along the sensing fiber. Using this information, the differential attenuation factor Δα can be calculated at every location along the optical fiber. This distributed differential attenuation factor Δα(z) can then be used to calculate a corrected temperature trace.

There are several issues to be aware of and to consider when considering using a double-ended system.
1. Using twice the fiber length requires twice the optical budget on the DTS instrument. This often limits double-ended system performance while reducing any margin in the optical budget.
2. Interrogating sensing fibers from two directions require twice the optical connections and drives system complexity.
3. Twice the fiber is exposed to the environment so Hydrogen induced attenuation will create twice the attenuation increase in a loop when compared to a single ended system.
4. The noise increases exponentially with distance as the signal levels decrease due to fiber attenuation, and this noise term show up in the distributed differential attenuation factor over distance Δα(z) and temperature trace.

Numbers 1 and 2 increase the total system cost while adding deployment complexity. Number 3 reduces the service life of the system. Number 4 impacts the quality of the data, which in turn makes the interpretation of temperature data more difficult. In many installations, it is impractical or even impossible to deploy double-ended systems.

The advantage of a double-ended system is the ability to correct for dynamic differential attenuation changes. The disadvantages are cost, complexity, system performance and data quality.

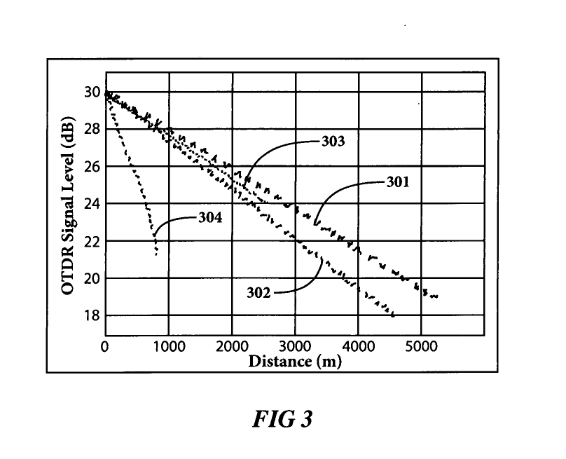

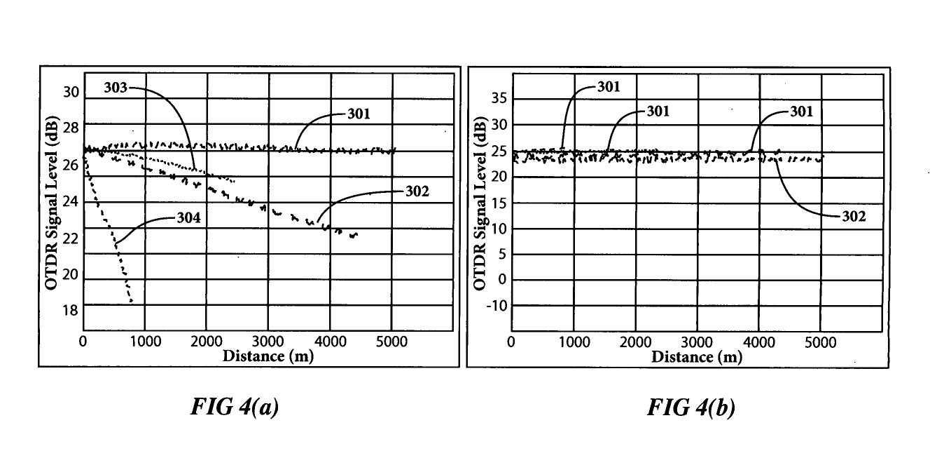

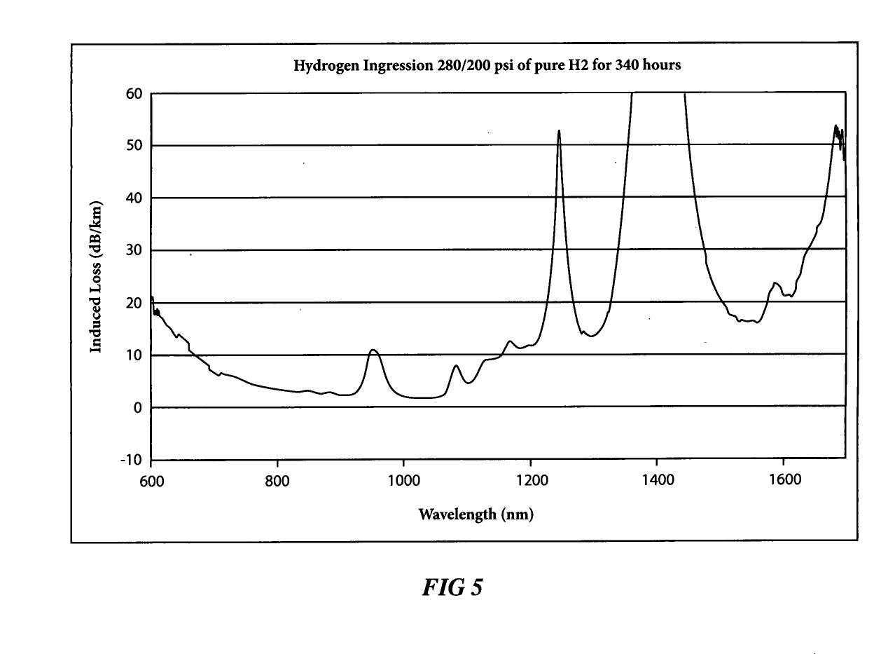

An alternate is the use of a single ended multi-laser technology. It addresses all of the issues with a double-ended system, while providing all the benefits of a single ended system. The type of system can be designed to be more tolerant to wavelength dependent attenuation. Careful selection of the laser wavelengths will provide signal paths with equal amount of round-trip attenuation for the launched light and backscattered Stokes and anti-Stokes components thus eliminating the effect of distributed differential attenuation Δα(z). The performance of a multi wavelength system will be illustrated in FIGS. 3 and 4.

FIG. 3 shows OTDR data for 4 different optical fibers at room temperature. Fiber probes 301, 302, and 303 are pristine fibers on shipping spools while the fiber probe 304 is recovered from a steam drive well in Canada. Fiber 304 was retrieved for failure analysis after the operator came to the conclusion that a single wavelength single ended system could not measure any useful temperature data due to hydrogen induced attenuation. The results in fiber probes 301,302, and 303 show expected linear optical attenuation values while fiber probe 304 shows high non-linear attenuation.

FIG. 4(a) show DTS data measured with a classical single wavelength DTS, and FIG. 4(b) show the same DTS data with a multi-wavelength DTS.

When the fibers are interrogated using a classical single ended DTS, fibers 301, 302, and 303 show a largely linear behavior FIG. 4(a). The slope in the measurement for fibers three fibers can be calibrated out by varying the differential attenuation Δα assuming the temperature is known at some point along the fiber. Each of the fibers must be individually calibrated for accurate measurements, but non-linear contributions cannot be calibrated out as can be seen on fiber probe 304 of FIG. 4(a). Fiber 304 shows a large non-linear temperature error due to the hydrogen-induced attenuation. In steam drive wells, the distributed differential attenuation would vary with time, temperature and hydrogen exposure making any calibration attempts inaccurate for single ended single wavelength systems.

The same fibers were interrogated using a single ended multi wavelength system and the results are shown in FIG. 4(b). The measured temperature data for all fiber probes, regardless of the difference in distributed differential attenuation, agrees well with the room temperature. This shows the capability of the multi wavelength technology to overcome some dynamic non-linear distributed differential attenuation variations.

To address the more difficult issues of long term exposure of a DTS fiber system in very hostile (high temperature and high free hydrogen concentration) environments this disclosure proposes a combination of a single ended multi wavelength DTS system and a Pure Silica Core hydrogen tolerant fiber in which both the DTS system and fiber system are engineered to maximize system performance and provide far better ability to address the dynamic non-linear distributed differential attenuation variations in high temperature hydrogen environments.

Fiber darkening, or hydrogen induced optical attenuation, is caused when hydrogen reacts with defect sites in optical fibers. The permanent hydrogen induced attenuation varies with fiber chemical composition, hydrogen concentration, temperature and exposure time. The induced optical fiber attenuation is therefore likely to be non-uniform along the length of the optical fiber as down-hole conditions vary along the well bore.

The next level of hydrogen mitigation is Pure Silica Core (PSC) optical fibers. Dopants and chemicals, the cause of permanent hydrogen induced attenuation, are neutralized from the optical fiber core. Free hydrogen will still induce wavelength dependent attenuation in Pure Silica Core optical fibers, but optical fibers can be engineered to show low loss at certain wavelengths. By design hydrogen induced attenuation due to free hydrogen show up at different wavelengths.

The fiber in FIG. 5 is a good example of such an engineered fiber in which the lower wavelengths show low attenuation in certain bands as a result of a focused engineering effort. The data in FIG. 5 is on a Pure Silica Core (PSC) optical fiber after 340 hours of hydrogen exposure at 280° C. with a hydrogen pressure of 200 pounds per square inch. It can be seen that while hydrogen ingression at these extreme conditions can have a serious deleterious effect over many parts of the wavelength spectrum there are some wavelength ranges in which the attenuation loss is potentially manageable. An example wavelength region is that between about 950 nanometers (nm) and 1070 nm.

The most common DTS systems are single wavelength systems operating at 1064 nm+/−40 nm, which means that they have an operating wavelength band between 1024 nm to 1104 nm, and will have to deal with the 1083 nm peak shown in FIG. 5. Free hydrogen in the optical fiber causes the attenuation peak at 1083 nm, and this peak will be present every time there is free hydrogen in any optical fiber. The amplitude of the 1083 nm peak will vary with hydrogen concentration.

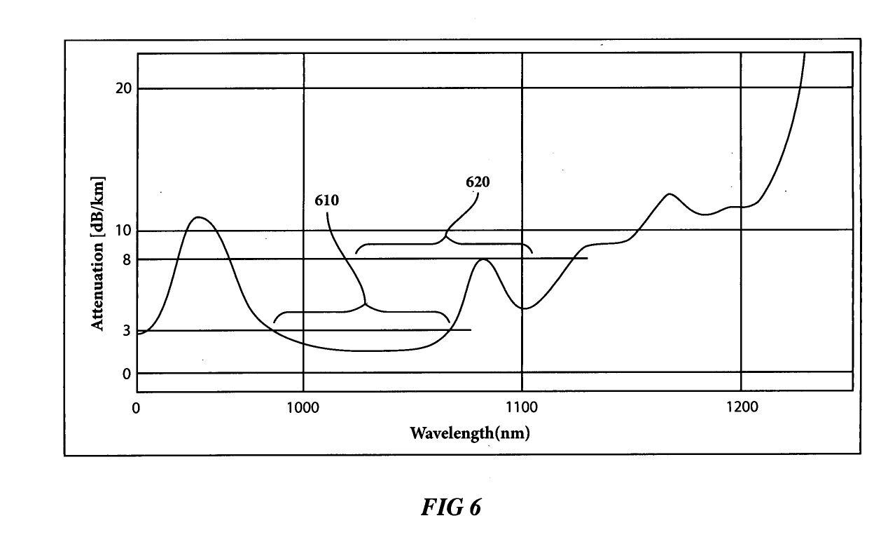

An aspect of the invention of this disclosure is the matching of a dual wavelength DTS system to the favorable wavelength band of a designed PSC fiber. As a preferred embodiment, a dual wavelength DTS system with an operating wavelength band between 980 nm to 1064 nm. The normal loss in the wavelength band between 980 nm to 1104 nm is around 2[dB/km]. With a 1,500 meters deep steam assisted gravity drainage (SAGD) well, this translates into a two-way loss of 2×1.5[km]×2[dB/km]=6[dB] of expected fiber loss for a single ended system. For a double ended system, the two way loss translates into 2×3.0[km]×2[dB/km]=12[dB] of expected fiber loss. The DTS operating bands must then be mapped on the fiber wavelength dependent attenuation graph, and the hydrogen-induced attenuation in the operating band must be evaluated. If we zoom in on the relevant wavelength band on the fiber in FIG. 5, and map the DTS operating bands, we get FIG. 6.

As seen in FIG. 6 the hydrogen induced attenuation peaks increase the highest attenuation level to 3[dB/km] for the 980 nm-1064 nm band, shown as 610, but the highest attenuation level for the 1024 nm-1104 nm band is increased to 8[dB/km].

The required hydrogen induced attenuation margin for the single ended dual wavelength system operating in the 980 nm-1064 nm is the difference between the original 2[dB/km] and the 3[dB/km] so 2×1.5[km]×1[dB/km]=3[dB].

The required hydrogen induced attenuation margin for a double ended single wavelength system operating in the 1024 nm-1104 nm is the difference between the original 2[dB/km] and the 8[dB/km] so 2×1.5[km]×6[dB/km]=18[dB]. This increase is quite considerable and the fiber test conditions for the fiber are quite severe at 200[psi] partial Hydrogen pressure. A 200 psi partial hydrogen pressure would translate into a 2,000 psi well pressure with 10% hydrogen concentration in the well.

Insufficient power margin will make the system fail when exposed to hydrogen at elevated temperatures. Free hydrogen in the optical fiber cause the attenuation peak at 1083 nm, and this peak will be present every time there is free hydrogen in any optical fiber. The amplitude of the 1083 nm peak will vary with hydrogen concentration.

The key decision for designing thermal monitoring systems in high temperature hydrogen environments is to match the fiber and DTS as a pair, where the DTS system operates in a wavelength band with minimum fiber attenuation increase during the service life of the asset.

In one aspect of such a PSC fiber—dual wavelength single ended DTS system a DTS system with a dual 1064 nm (primary) and 980 nm (secondary) are used. In operation this is done by first, in a measurement mode, providing the primary light source light pulse energy into a sensing fiber; then collecting backscattered Raman Stokes and anti-Stokes light components; calculating temperatures using the intensities of the backscattered Raman Stokes and anti-Stokes light components; then during a correction mode selecting the secondary light source and providing pulses of said secondary light source to the sensing fiber; collecting a backscattered Raman Stokes component of that secondary light source; using that Raman Stokes component collected from the secondary light source in said correction mode to correct a Raman anti-Stokes profile collected from the primary light source while in measurement mode; and calculating a corrected temperature from the corrected anti-Stokes profile.

In another aspect of such a PSC fiber—dual wavelength single ended DTS system a DTS system with a dual 1064 nm (primary) and 980 nm (secondary) can again be used but in a different manner. In operation this is done by first, injecting primary light energy into a sensor fiber using a primary light source; then collecting backscattered Rayleigh and anti-Stokes light components from the primary light energy; and measuring the attenuation of the backscattered Rayleigh light component and using it to correct the anti-Stokes light components; then injecting secondary light energy into the sensor fiber using a secondary light source; and collecting backscattered Rayleigh and Stokes light components of that secondary light source; then measuring the attenuation of the backscattered Rayleigh light component and using it to correct the Stokes light components; and calculating a temperature using the ratio of the corrected back-scattered anti-Stokes signal of the primary light energy and the corrected back-scattered Stokes signal of the secondary light energy.

In another aspect of such a PSC fiber—dual wavelength single ended DTS system a DTS system with a dual 1030 nm (primary) and 990 nm (secondary) are chosen. These also fall in the range of low hydrogen attenuation of FIG. 6 and are chosen so that the anti-Stokes light component of the primary light source is essentially the same as the wavelength of the secondary light source. In operation this is done by first, injecting primary light energy into a sensor fiber using the primary light source; collecting back-scattered light energy at the Raman anti-Stokes wavelength of the primary light energy and measuring its intensity; injecting secondary light energy into the fiber at the Raman anti-Stokes wavelength of the primary light energy using a secondary light source; collecting back-scattered light energy at the Raman Stokes wavelength of the secondary light energy and measuring its intensity; and calculating a temperature using the back-scattered anti-Stokes signal of the primary light energy and the back-scattered Stokes signal of the secondary light energy.

In another aspect of these embodiments the selection of the measurement mode or correction mode can be made by use of a commercially available optical switch. This proposed scheme provides stable and accurate calibration.

In these embodiments, the primary light source and the secondary light source may also be the same light source, i.e., a dual wavelength laser source operable to provide at least two optical signals to the sensing fiber. In this case optical switches may not be needed. The dual wavelength laser source may operate at the primary wavelength and the key bands may be collected. Next, the dual wavelength laser source may operate to a secondary wavelength and at the remaining key reflected bands may be collected.

In another aspect the two lasers use a single pulse modulating circuit to operate the light sources. This aspect provides common modulating parameters for two lasers continuously. It is difficult to synchronize two consecutive pulses with identical condition in parameters such as modulating current amplitude, repetition rate and the pulse widths by utilizing two individual pulse modulating circuits. The present invention can have a single pulse modulating circuit that drives both the measurement mode and correction mode—that is, the primary light source and the secondary light source.

Surface cabling and surface splices may add another 2-6[dB] but should normally not change when properly installed. Any problems with the surface cabling can be diagnosed using the Stokes trace of a DTS system or using a telecommunication grade OTDR.

All of the methods disclosed and claimed herein may be executed without undue experimentation in light of the present disclosure. While the disclosure may have been described in terms of preferred embodiments, it will be apparent to those of ordinary skill in the art that variations may be applied to the components described herein without departing from the concept, spirit and scope of the disclosure. All such similar substitutes and modifications apparent to those skilled in the art are deemed to be within the spirit, scope, and concept of the disclosure as defined by the appended claims.

1. A method for automatic calibration of temperature measurement in high temperature hydrogen rich environments in a system using a fiber optic distributed sensor comprising the steps of:
a. in a measurement mode providing a primary light source light pulse energy into a sensing fiber;
i. collecting backscattered Raman Stokes and anti-Stokes light components;
ii. calculating temperatures using the intensities of the backscattered Raman Stokes and anti-Stokes light components;
b. during a correction mode selecting a secondary light source and providing pulses of said secondary light source to the sensing fiber;
i. collecting a backscattered Raman Stokes component of that secondary light source;
ii. using that Raman Stokes component collected from the secondary light source in said correction mode to correct a Raman anti-Stokes profile collected from the primary light source while in measurement mode; and
iii. calculating a corrected temperature from the corrected anti-Stokes profile.
c. wherein the fiber optic distributed sensor is a pure silicon core (PSC) fiber; and
d. wherein the primary light source is a 1064 nm wavelength source and the secondary light source is a 980 nm wavelength source.

2. A method for automatic calibration of temperature measurement in high temperature hydrogen rich environments in a system using a fiber optic distributed sensor comprising the steps of:
e. injecting primary light energy into a sensor fiber using a primary light source;
f. collecting backscattered Rayleigh and anti-Stokes light components from the primary light energy;
g. measuring the attenuation of the backscattered Rayleigh light component and using it to correct the anti-Stokes light components;
h. injecting secondary light energy into the sensor fiber using a secondary light source;
i. collecting backscattered Rayleigh and Stokes light components of that secondary light source;
j. measuring the attenuation of the backscattered Rayleigh light component and using it to correct the Stokes light components;
k. calculating a temperature using the ratio of the corrected back-scattered anti-Stokes signal of the primary light energy and the corrected back-scattered Stokes signal of the secondary light energy
l. wherein the fiber optic distributed sensor is a pure silicon core (PSC) fiber; and
m. wherein the primary light source is a 1064 nm wavelength source and the secondary light source is a 980 nm wavelength source.

3. A method for automatic calibration of temperature measurement in high temperature hydrogen rich environments in a system using a fiber optic distributed sensor comprising the steps of:
a. injecting primary light energy into a sensor fiber using a primary light source;
b. collecting back-scattered light energy at the Raman anti-Stokes wavelength of the primary light energy and measuring its intensity;
c. injecting secondary light energy into the fiber at the Raman anti-Stokes wavelength of the primary light energy using a secondary light source;
d. collecting back-scattered light energy at the Raman Stokes wavelength of the secondary light energy and measuring its intensity; and
e. calculating a temperature using the back-scattered anti-Stokes signal of the primary light energy and the back-scattered Stokes signal of the secondary light energy.
f. wherein the fiber optic distributed sensor is a pure silicon core (PSC) fiber; and
g. wherein the primary light source is a 1030 nm wavelength source and the secondary light source is a 990 nm wavelength source.
